(19) United States
(12) Patent Application Publication
(10) Pub. No.: US 2014/0033389 A1
(43) Pub. Date: Feb. 6, 2014

(54) Polychloroprene-free wetsuit and material

(71) Applicant: Robert Falken, Oceanside, CA (US)

(72) Inventor: Robert Falken, Oceanside, CA (US)

(21) Appl. No.: 13/564,875

(22) Filed: Aug. 2, 2012

(51) Int. Cl. B32B 27/12; B32B 38/00; B63C 11/04

(52) U.S. Cl. 2/2.15; 428/220; 156/93

(57) ABSTRACT

A polychloroprene-free wetsuit and material is described that uses closed cell thermoplastic elastomer foam. Depending on the wetsuit application, the density of the closed cell thermoplastic elastomer foam may vary. In many wetsuit applications low densities such as less than 0.25 grams/cubic centimeter and preferably 0.10 to 0.20 grams/cubic centimeter are desirable.

### BACKGROUND OF THE INVENTION

Surfers, jet skiers, wake boarders, windsurfers, kayakers, whitewater rafters, scuba divers, and snorkelers use wetsuits for comfort and protection during water recreation. Essentially, wetsuits are a form of thermal covering that traps a thin layer of water against the wearers skin to form under an insulating material to be warmed by body heat. The insulating material commonly used for wetsuits is polychloroprene, also known as neoprene, a product of synthetic rubber. Unfortunately, polychloroprene has several major disadvantages. These include rubber allergy and high toxicity among others. With regard to rubber allergy, 15% of the world's population is allergic to polychloroprene. The American Contact Dermatitis Society labeled neoprene rubber as a common source of mixed dialkyl thioureas, which happens to have been labeled the Allergen of the Year in 2009. As for polychloroprene's toxicity, the material contains formaldehyde, phthalates, lead, and chlorine, which are all known to be harmful to humans.

Thus, there exists a clear need for a wetsuit material that is not based on polychloroprene, and does not have the allergen potential or the levels of toxicity.

It is thus an object of the present invention to provide a wetsuit and a wetsuit material that is polychloroprene-free. It is another object of the present invention to provide a wetsuit and a wetsuit material that contains polychloroprene-free material such as hypoallergenic thermoplastic elastomer foam. It is a further object of the present invention to provide a wetsuit and a wetsuit material that is polychloroprene-free and insulates as well or better than polychloroprene. It is yet another object of the present invention to provide a wetsuit and a wetsuit material that is polychloroprene-free and withstands tearing, rough handling and severe conditions. It is yet another object of the present invention to provide a wetsuit and a wetsuit material that is polychloroprene-free and is inherently flexible. It is yet another object of the present invention to provide a wetsuit and a wetsuit material that is polychloroprene-free and is inert to most chemical agents. It is still another object of the present invention to provide a wetsuit and a wetsuit material that is polychloroprene-free and is free of formaldehyde, phthalates, lead, and chlorine.

### SUMMARY OF THE INVENTION

In accordance with the present invention, there is provided a polychloroprene-free wetsuit and material comprising closed cell thermoplastic elastomer foam.

The foregoing paragraph has been provided by way of introduction, and is not intended to limit the scope of the invention as described in this specification, drawings and claims.

### BRIEF DESCRIPTION OF THE DRAWINGS

The preferred and alternative embodiments of the present invention are described in detail below with reference to the following drawings.

FIG. 1 is a cross section of the polychloroprene-free wetsuit material;

FIG. 2 is a cross section of the polychloroprene-free wetsuit material with a fabric covering;

FIG. 3 is a cross section of the polychloroprene-free wetsuit material with an inner liner;

FIG. 4 is a cross section of the polychloroprene-free wetsuit material with a fabric covering and an inner liner;

FIG. 5 is the polychloroprene-free wetsuit of the present invention in a men's full suit;

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification, drawings and claims.

### DESCRIPTION OF THE PREFERRED EMBODIMENTS

Wetsuit construction is performed through the use of automated machine cutting and seam bonding or hand cutting, tailoring and seam bonding. The present invention and the various embodiments depicted herein rely on the use of thermoplastic elastomer foam (TPE foam), which can be fabricated into wetsuits using either automated or hand methods, or a combination thereof.

Thermoplastic elastomer foam (TPE foam) is made up of a class of copolymers or a physical mix of polymers consisting of materials with both thermoplastic and elastomeric properties. Generally, thermoplastic elastomer foam consists of a thermoplastic elastomer (thermoplastic resin), blowing agent, additives, and fillers. Thermoplastic elastomer foam is considered a generally low modulus, flexible material that can be stretched repeatedly which is an ideal characteristic for the production of the present invention.

The first step in the production of thermoplastic elastomer foam involves the selection of a foamable thermoplastic elastomer having a suitable hardness value to permit production of soft, low-density foam. In practice the resulting foam must exhibit compressibility (i.e. load bearing) characteristics that allow the foam to deform easily and still resist permanent deformation (compression set) when the load is removed.

According to conventional technique, a thermoplastic elastomer foam may be produced by feeding a thermoplastic resin into an extruder and, through the shearing action of one or more screws, melting the resin continuously in the barrel of the extruder. In an intermediate or a mixing section, a blowing agent, usually in a liquid or gaseous state, is continuously injected into the molten resin. In some instances, a chemical blowing agent may be dispersed throughout the particulate resin in a powder form before the resin is fed to the extruder as discussed in U.S. Pat. No. 4,107,260. The entire disclosure of which is incorporated herein by reference only. In either case, the extruder screw is designed to mix and dissolve the blowing agent as uniformly as possible in the molten resin. Thorough, uniform mixing is essential to the production of high quality foam. The resultant mixture must be maintained under carefully controlled temperatures and pressures within the extruder in order to prevent the volatilization of the blowing agent.

When the molten mixture is forced through a die, the material undergoes decompression to atmospheric pressure so that the blowing agent separates within the body of material as bubbles. If the temperature is too high, there is overexpansion and the cells rupture. If the temperature is too low, there is incomplete expansion, resulting in low quality foam. In many instances, the temperature window between overexpansion and underexpansion is only a few degrees Fahrenheit.

The thermoplastic elastomer foam may contain additives, if necessary for a certain purpose of the polychloroprene-free wetsuit of the present invention, each in an amount by which the mechanical strength and the flexibility are not affected adversely, such as antistatic agent, weatherability-imparting agent, UV absorber, glidant, antibacterial agent, antifungal agent, tackifier, softener, plasticizer, filler such as titanium oxide, carbon black, dry silica, wet silica, aramid fiber, mica, calcium carbonate, potassium titanate whisker, talc, barium sulfate, and the like.

Various densities of thermoplastic elastomer foam (TPE foam) that has been expanded into a closed cell structure may be used to make the polychloroprene-free wetsuit of the present invention. Low densities, for example, less than about 0.25 grams/cubic centimeter, and preferably 0.10 to 0.20 grams/cubic centimeter, are well suited for making the polychloroprene-free wetsuit of the present invention. Other densities may also be used to make the polychloroprene-free wetsuit of the present invention.

For a general understanding of the present invention, reference is made to the drawings.

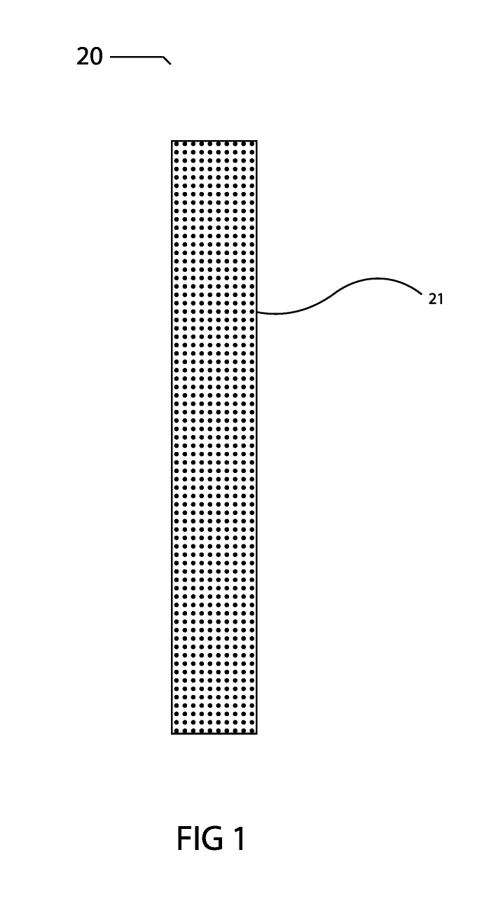

FIG. 1, a cross sectional diagram 20 of the polychloroprene-free wetsuit material is shown. In one embodiment of the present invention the polychloroprene-free wetsuit is made from thermoplastic elastomer foam, 21. The thickness of the material may vary, as does the neoprene in neoprene wetsuits, depending on the specific application where the wetsuit is used. Examples of common material thicknesses include 2 millimeter, 3 millimeter, 4 millimeter, and the like. Thermoplastic elastomer foam may be produced in various colors to further enhance the desirability of the polychloroprene-free wetsuit of the present invention.

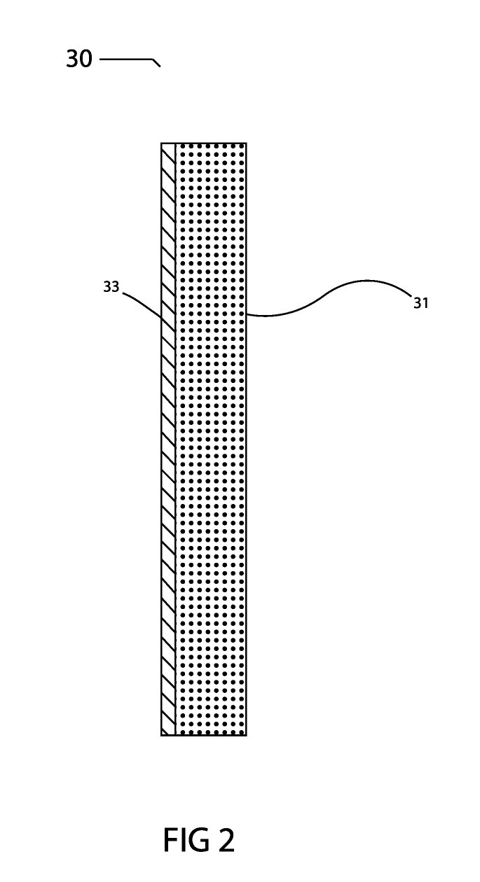

FIG. 2, in some embodiments of the present invention, a fabric covering 33, as depicted in the cross sectional diagram 30 of the polychloroprene-free wetsuit material with a fabric covering, may be used to further strengthen and reinforce the TPE foam 31. The fabric covering 33 is bonded to the TPE foam 31 using an adhesive, a heat process, a cold process, or the like. Such fabric covering may be a woven polypropylene, woven nylon, aramid fiber, Lycra, spandex, or the like.

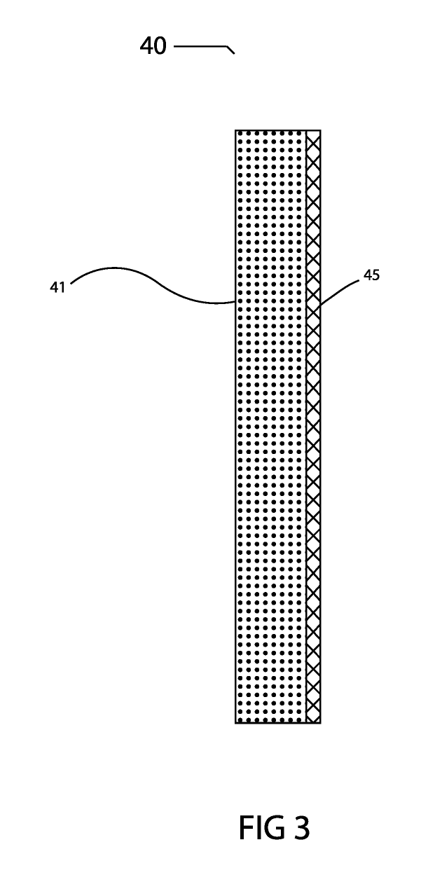

FIG. 3, in some embodiments of the present invention, an inner liner 45, as depicted in the cross sectional diagram 40 of the polychloroprene-free wetsuit material with an inner liner, may he used to provide added comfort to the user. The inner liner is bonded to the TPE foam 41 using an adhesive, a heat process, a cold process, or the like. Such inner liner may be a fleece polypropylene, spun nylon, jersey, or a low friction coating such as an SCS coating, Lycra, spandex, or the like.

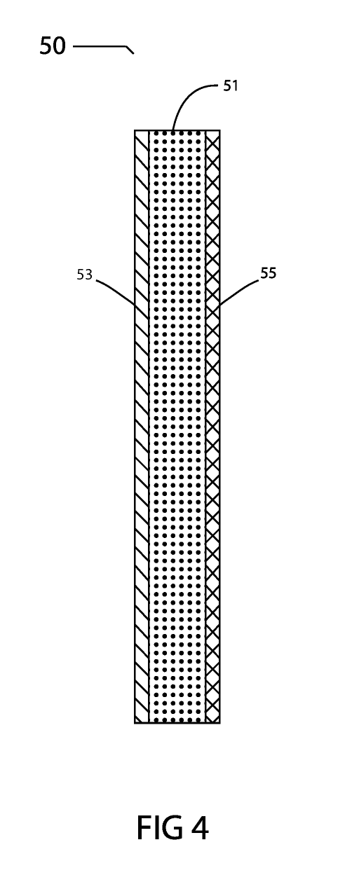

FIG. 4, in some embodiments of the present invention, an inner liner 55 and a fabric covering 53 may be applied to the TPE foam 51 as shown in FIG. 4, which is a cross sectional diagram 50 of the polychloroprene-free wetsuit material with a fabric covering and an inner liner. The inner liner 55 is bonded to the TPE foam 51 using an adhesive, a heat process, a cold process, or the like. Such inner liner may be a fleece polypropylene, spun nylon, jersey, a low friction coating such as an SCS coating. Lycra, spandex, or the like. In a similar fashion, the fabric covering 53 is bonded to the TPE foam 51 using an adhesive, a heat process, a cold process, or the like. The fabric covering 53 may be a woven polypropylene, woven nylon, aramid fiber, Lycra, spandex, or the like.

In some embodiments of the present invention, other materials may be placed on either side of the TPE foam 51 to enhance performance or to achieve desirable characteristics of the polychloroprene-free wetsuit.

To make a polychloroprene-free wetsuit of the present invention, techniques such as those known to those skilled in the art in the field of neoprene wetsuit fabrication and tailoring, are employed. For example, the thermoplastic elastomer foam material is cut to various patterned pieces, the pieces are joined together using a technique such as gluing or double gluing (glue is applied to both sides of each piece of material to be joined together), the joined and glued together pieces may optionally be nipped (a technique where pressure is applied to the joined seams), a piece of material such as heat welded tape made from a material such as stretch nylon is then placed on the inside of the seam and glued in place, the pieces are then blind stitched from one or both sides, and optionally the seams are covered with a material such as heat welded tape or the like. To complete the polychloroprene-free wetsuit, a zipper or zippers are added along with logos, and the like. As known to those skilled in the art, the steps heretofore described may be modified or adapted to various situations, materials, and wetsuit designs.

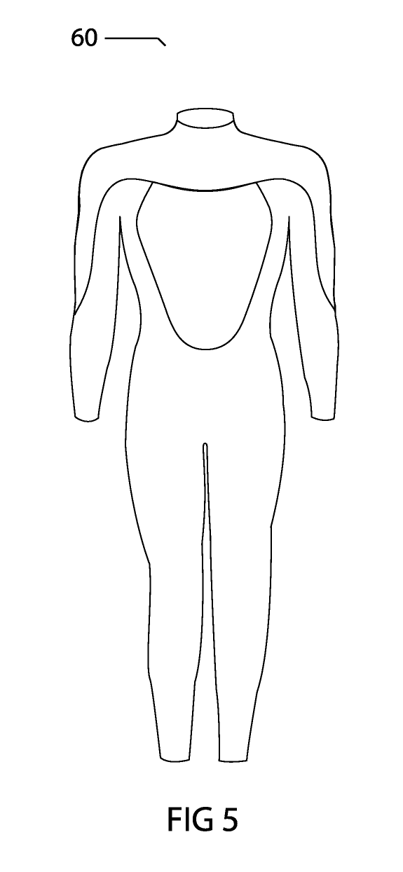

FIG. 5, an example of polychloroprene-free wetsuit is depicted in FIG. 5. Variations and modifications to the polychloroprene-free wetsuit of the present invention will be known to those skilled in the art. The example depicted in FIG. 5 is shown by example only, and is not intended to be limiting. FIG. 5 is a polychloroprene-free wetsuit of the present invention in a men's full suit 60. The resulting polychloroprene-free wetsuit may be of any style and size desired.

It is therefore apparent that there has been provided, in accordance with the various objects of the present invention a polychloroprene-free wetsuit and material. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification, drawings, and claims.

What is claimed is:

1. A wetsuit comprising cut patterned pieces of polychloroprene-free closed cell thermoplastic elastomer foam material; wherein the polychloroprene-free closed cell thermoplastic elastomer foam material has a low density of less than 0.25 grams/cubic centimeter; and wherein the cut patterned pieces of polychloroprene-free closed cell thermoplastic elastomer foam material have a thickness in the range of about 2 millimeters to about 5 millimeters.

2. The polychloroprene-free wetsuit of claim 1, further comprising an outer fabric covering.

3. The polychloroprene-free wetsuit of claim 2, wherein the outer fabric covering is woven nylon.

4. The polychloroprene-free wetsuit of claim 2, wherein the outer fabric covering is aramid fiber.

5. The polychloroprene-free wetsuit of claim 2, wherein the outer fabric covering is spandex.

6. The polychloroprene-free wetsuit of claim 2, wherein the outer fabric covering is woven polypropylene.

7. The polychloroprene-free wetsuit of claim 1, further comprising an inner liner.

8. The polychloroprene-free wetsuit of claim 7, wherein the inner liner is spun nylon.

9. The polychloroprene-free wetsuit of claim 7, wherein the inner liner is fleece polypropylene.

10. A material for a wetsuit comprising polychloroprene-free closed cell thermoplastic elastomer foam material and an outer fabric covering; wherein the polychloroprene-free closed cell thermoplastic elastomer foam material has a low density of less than about 0.25 grams/cubic centimeter; and wherein the material has a thickness in the range of about 2 millimeters to about 5 millimeters.

11. The polychloroprene-free material of claim 10, wherein the outer fabric covering is woven nylon.

12. The polychloroprene-free material of claim 10, wherein the outer fabric covering is aramid fiber.

13. The polychloroprene-free material of claim 10, wherein the outer fabric covering is spandex.

14. The polychloroprene-free material of claim 10, wherein the outer fabric covering is woven polypropylene.

15. The polychloroprene-free material of claim 10, further comprising an inner liner.

16. The polychloroprene-free material of claim 15, wherein the inner liner is fleece polypropylene.

17. The polychloroprene-free material of claim 15, wherein the inner liner is spun nylon.

18. A process for the manufacture of a wetsuit, the process comprising the steps of: cutting patterned pieces of polychloroprene-free closed cell thermoplastic elastomer foam material; joining the patterned pieces of polychloroprene-free closed cell thermoplastic elastomer foam material with an adhesive; stitching the patterned pieces of polychloroprene-free closed cell thermoplastic elastomer foam material with seams; and taping the seams.
